(19) United States
(12) Patent Application Publication
(10) Pub. No.: US 2013/0054689 A1
(43) Pub. Date: Feb. 28, 2013

(54) REDEEMABLE CONTENT SPECIFIC TO GROUPS

(71) Applicants: Jennifer Woldman, Foster Ciry, CA (US); Cindy De Guzman, Foster City, CA (US); Grace Chen, Foster City, CA (US)

(72) Inventors: Jennifer Woldman, Foster Ciry, CA (US); Cindy De Guzman, Foster City, CA (US); Grace Chen, Foster City, CA (US)

(73) Assignee: SONY COMPUTER ENTERTAINMENT AMERICA LLC

(21) Appl. No.: 13/220,315

(22) Filed: Aug. 29, 2011

(51) Int. Cl. G06F 15/16

(52) U.S. Cl. 709/204

(57) ABSTRACT

Information regarding a user may be indicative of membership in a group. Such information may be maintained for every user associated with a particular system or title. In instances, redeemable content may be offered exclusively to a group. Requests for such content may therefore be received and evaluated to determine whether the requesting user is a member of the particular group. The determination includes an evaluation of information associated with the requesting user. In some instances, the information associated with the requesting user is a user identifier that is indicative of the group membership, and the user identifier may be included in the request. If the user is indeed determined to be a member of the group, access to the redeemable content is granted. Alternatively, if the user is not determined to be a member of the group, access to the redeemable content is denied.

### BACKGROUND OF THE INVENTION

1. Field of the Invention

The present invention generally relates to redeemable content. More specifically, the present invention relates to redeemable content specific to groups.

2. Description of the Related Art

Presently available digital media may encompass a range of audio, video, video games, and other online and software applications. Users of such digital media may naturally or deliberately congregate into groups with respect to a particular title of digital media. For example, massively multiplayer online role-playing games (MMORPGs) may involve large numbers of players who voluntarily associate and collaborate within a particular game title. The ability of users to form and interact in groups may be a source of engagement, thereby building user loyalty to the title or family of titles. Such ad hoc associations may also be indicative of common interests, tastes, and relationships. Publishers of digital media may, therefore, wish to engage with such groups of users for marketing, branding, product development, and various other purposes.

One way to provide services or content to a group is to provide a single voucher that can only be used as many number of times as there are group members. Alternatively, some publishers may generate multiple single-use vouchers for each group member. One disadvantage to both approaches is that there is presently no way to prevent the voucher(s) from being transferred to a user who is not part of the group. For example, in some MMORPGs, clan affiliation, status, and ranking may be quite valuable to a user, since these attributes may have required much time, effort, and/or expense to achieve. A publisher who wishes to provide an exclusive clan-specific character skin (or status-specific skin, or ranking-specific skin) may further wish to prevent clan outsiders from using that character skin. That is because use by outsiders may render that skin less desirable to clan members, thereby undermining efforts to engage that particular clan.

Engaging such groups may further be complicated by the fact that the membership of such groups may be continually in flux. Members may join, leave, rejoin, or change account (identity) information. A rewards program that is based on account longevity, for example, may be difficult to administer, since the tiers are continually changing (i.e., every account is continually aging). As such, it is difficult to determine how many redemption codes or vouchers to generate, who should receive such vouchers, and how to restrict use of such vouchers to the intended recipients.

Some media titles may not officially recognize groups as such. For example, a particular game may allow for team play, but does not necessarily track information regarding the particular teams or the members thereof. While certain users may regularly play that game title as a team, there may be no official records regarding that team.

There is a need for improved systems and methods for providing redeemable content specific to groups.

### SUMMARY OF THE INVENTION

Embodiments of the present invention include systems and methods for providing redeemable content specific to a group. Information may be maintained for users associated with a particular system or title, including information that is indicative of membership in one or more groups. Where redeemable content may be offered exclusively to a group, incoming requests for such content may therefore be received and evaluated to determine whether the requesting user is a member of the particular group associated with the redeemable content. The determination may include an evaluation of information associated with the requesting user. In some instances, the information associated with the requesting user is a user identifier that is indicative of the group membership, and the user identifier may be included in the request. If the user is indeed determined to be a member of the group, access to the redeemable content is granted. Alternatively, if the user is not determined to be a member of the group, access to the redeemable content is denied.

Various embodiments of the present invention include methods for providing redeemable content specific to a group. Such methods may include storing information associated with members of a group such that the stored information for each member is indicative of his/her membership in the group. Methods may further include receiving a request concerning access to redeemable content that is restricted to members of a particular group and executing instructions to determine whether the requesting user is a member of the group. If the information associated with the requesting user is indicative of membership in the group, access to the redeemable content may be granted. If the information associated with the requesting user is not indicative of membership in the group, access to the redeemable content may be denied.

Embodiments of the present invention may further include systems for providing redeemable content specific to a group. Such systems may include memory for storing information regarding membership in the group, an interface for receiving a request concerning access to redeemable content that is restricted to the members of the group, and a processor for executing instructions to evaluate information associated with the requesting user to determine whether the requesting user is a member of the group. As in the method, if the information associated with the requesting user is indicative of membership in the group, access to the redeemable content may be granted. If the information associated with the requesting user is not indicative of membership in the group, access to the redeemable content may be denied.

Other embodiments of the present invention include non-transitory computer-readable storage media on which is embodied instructions executable to provide redeemable content specific to groups in general accordance with the method previously set forth above.

### BRIEF DESCRIPTION OF THE DRAWINGS

FIG. 1 illustrates a network environment in which a system for providing redeemable content specific to groups may be implemented.

FIG. 2A illustrates a user database accessible to the server of FIG. 1.

FIG. 2B illustrates a group database accessible to the server of FIG. 1.

FIG. 2C illustrates a redeemable content database accessible to the server of FIG. 1.

FIG. 3 is a flowchart illustrating a method for providing redeemable content specific to groups.

### DETAILED DESCRIPTION

Embodiments of the present invention allow for providing redeemable content specific to a group. Such methods may include storing information associated with members of a group such that the stored information for each member is indicative of his/her membership in the group. Methods may further include receiving a request concerning access to redeemable content that is restricted to members of a particular group and executing instructions to determine whether the requesting user is a member of the group. The redeemable content may include any digital media, prizes (real or virtual), services, rights, or privileges associated with one or more media titles. To effectuate the redemption of such content, the requesting user is verified as being a member of a group that is allowed to access the redeemable content. If the information associated with the requesting user is indicative of membership in the group, access to the redeemable content may be granted. If the information associated with the requesting user is not indicative of membership in the group, access to the redeemable content may be denied.

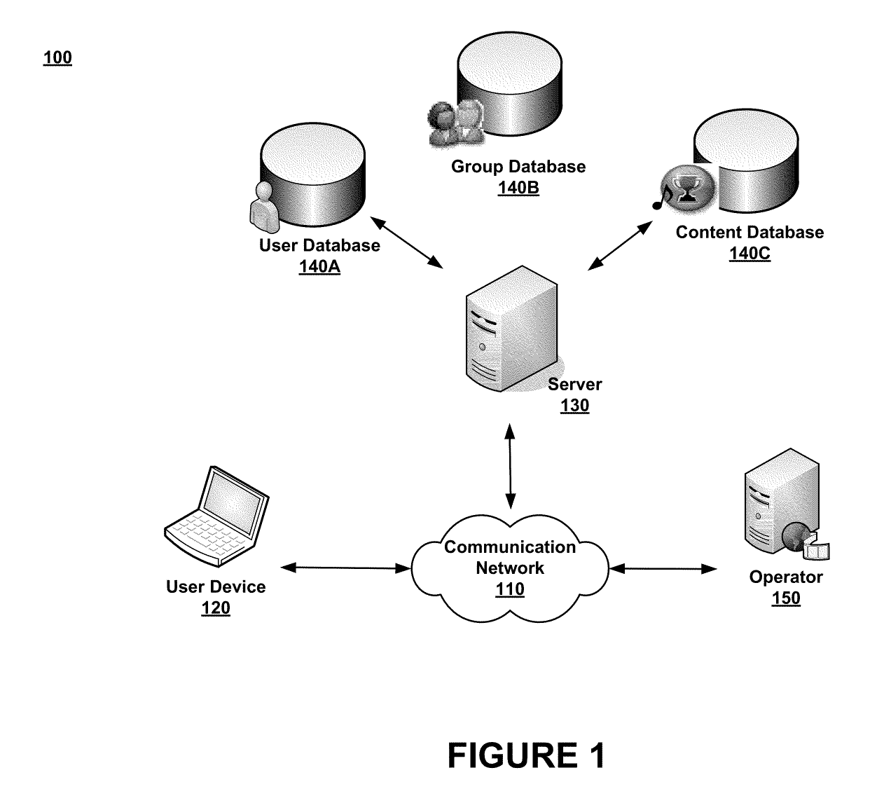

FIG. 1 illustrates an exemplary network environment 100 in which a system for providing redeemable content specific to groups may be implemented. In network environment 100, one or more user devices 120 may be in communication with a server 130, via a communication network 110. Server 130 may also be in communication with one or more databases 140, which may encompass a user database 140A, a group database 140B, and/or a redeemable content database 140C. In addition, an operator device 150 may also communicate with the other devices in network environment 100 via communications network 110.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of environment 100.

Users may use any number of different electronic user devices 120, such as mobile phones, smartphones, personal digital assistants (PDAs), portable computing devices (e.g., laptop, netbook, tablets), desktop computing devices, game console, handheld gaming device, or any other type of computing device capable of communicating over communication network 110. User device 120 may be further associated with or accessory to a general-purpose computer, a set-top box, a Blu-Ray® player, an electronic gaming system, or a home entertainment device (e.g., Sony PlayStation®3), as well as any one of a number of portable media devices (e.g., Sony PlayStation® Portable (PSP®)). Each user device 120 may also be configured to access data from other storage media, such as memory cards or disk drives as may be appropriate in the case of downloaded content. User device 120 may include standard computing components such as network and media interfaces, non-transitory computer-readable storage (memory), and processors for executing instructions that may be stored in memory.

Server 130 can receive and process communications sent by user devices 120. Server 130 may include any computing device as is known in the art, including standard computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Server 130 may also receive a request sent by user device 120 concerning access to certain redeemable content, such as may be stored in redeemable content database 140C. Before access to that redeemable content is granted or denied, server 130 evaluates information associated with the user of user device 120 to determine whether that user is part of a particular group. For example, a publisher may have a promotion awarding a redeemable prize to a particular group of users (e.g., members of a particular clan, users having a particular account status, long-time users). A user request may include certain information (e.g., an identifier) that may indicate or may be used to derive information regarding group affiliation of the user.

To facilitate the determination of whether a user is part of a group, server 130 of FIG. 1 may consult with a user database 140A, a group database 140B, and/or a redeemable content database 140C. These databases 140A-C may be local or remote to the server 130. Further, the information in the databases 140A-C may also be stored separately as illustrated in FIG. 1, or aggregated in one location. Server 130 can access the stored data in the databases 140A-C and provide that data, or information derived from or related to the same, to user devices 120. Conversely, the server 130 may receive information from user devices 120 and store the same in any of user database 140A, group database 140B, and/or redeemable content database 140C, as is appropriate.

Upon receiving a request, server 130 may evaluate the request to determine, inter alfa, who the requesting user is and what redeemable request is being requested. In some instances, the request may further explicitly indicate what group the user is affiliated with. Alternatively, server 130 may determine, based on information provided by user database 140A and/or group database 140B, that the requesting user is a member of a particular group. Moreover, server 130 may further determined, based on information provided by group database 140B and/or redeemable content database 140C, that the requested content is restricted to a particular group. Finally, server 130 may determine whether to grant or deny access based on whether the user is a member of the particular group(s) permitted to access the requested content.

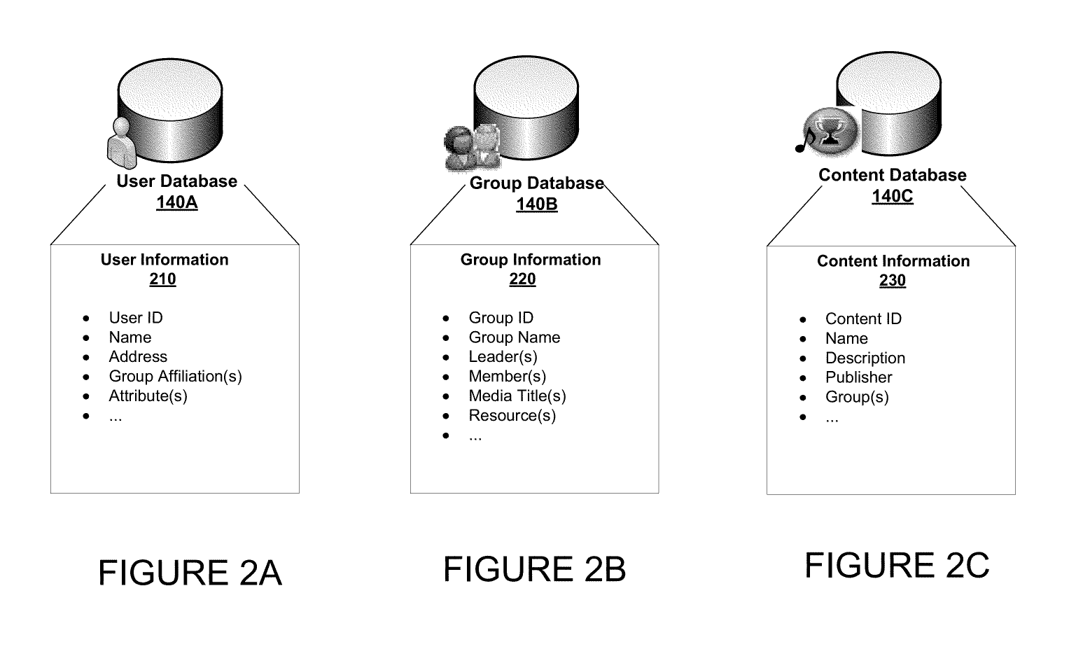

Information may be sent from the user device 120 over the communication network 110 to the server 130 for storage in one or more databases, including a user database 140A, group database 140B, and/or a redeemable content database 140C. The server 130 can later access data stored in any of the databases 140A-C for various purposes including providing redeemable content to specific group(s). Databases 140A-C are discussed in more detail in conjunction with FIGS. 2A-C.

Operator device 150 may be associated with a publisher of a media title or any redeemable content, a systems administrator, a media franchise operator, or any party that wishes to make redeemable content available to users in network environment 100. Operator device 150 may be similar to user device 120 with respect to such standard computing components such as network and media interfaces, non-transitory computer-readable storage (memory), and processors for executing instructions that may be stored in memory. Operator device 150 allows an entity to communicate regarding any redeemable content the entity wishes to offer and to specify the requirements for accessing such redeemable. For example, a game publisher may use operator device 150 to promote a game tournament to clans in a particular game title and to offer tournament- and/or clan-specific skins to tournament participants. A user requesting a skin may therefore need to be verified as being a tournament participant and being a member of a certain clan before the user is given access to the skin.

FIG. 2A illustrates a user database 140A accessible to the server of FIG. 1. The user database 140A may include user information 210 with respect to a multitude of users. Any type of user information 210 may be stored for a particular user, including name, user identifier, address/geographic location, any user devices 120 associated with the user, any user attributes (including group affiliations), any media titles associated with the user, purchase history, play history, etc. The user database 140A may receive information and/or updates concerning users based on a user registration, registration of a new user device 120, registration of new media titles, ongoing user behavior or interaction with respect to one of the media titles (e.g., joining a group, accumulating points, change in status within a game), registration for a service, and requests for updates.

A user may register—either manually or through an automatic exchange of data over network 110—for a user identifier and/or device identifier for user device 120. While a user identifier may specifically identify a particular user, a device identifier may be used by the server 130 to identify a particular user device and by extension, a user of the user device 120. In some instances, one identifier may be used to identify the user and various other user attributes, including user device 120, user location, group affiliation, title affiliation, etc. Such an identifier may be included in a request sent by the user to server 130. A first-time user may be prompted by the server 130 to enter certain user information, which may also be stored in user database 140A. Some information, such as group affiliation, may require approval (e.g., by a group leader) before being stored in user database 140A as a user attribute of the particular user.

FIG. 2B illustrates a group database 140B accessible to the server of FIG. 1. Group database 140B may include group information 220 with respect to a multitude of groups. Any type of group information 220 may be stored for a particular group, including group name, group leader(s), group members, roles/status of group members within the group, group attributes (e.g., game wins/losses as a team), and various group-specific information (e.g., group-specific redemption codes, content). In some embodiments, certain users may be designated group leaders (e.g., by virtue of having started the group or by selection by their fellow group members). Such group leader(s) may be able to register a group and manage group information (e.g., membership information). For example, a group leader may provide updates to group database 140B to indicate changes to the group membership (e.g., new member, departed member). Such information may be automatically populated to the stored user information 210 for each user who is a member of the group or who is no longer a member of the group. While group membership may remain somewhat ad hoc and controlled by the group leaders or the collective group, group database 140B allows for publishers, systems administrators, etc., to track information regarding a particular group and to interact with multiple users on a group basis. In some media titles, group registration may further require approval by a publisher, systems administrator, etc. Conversely, groups may use group database 140B to maintain up-to-date records regarding group membership, rankings, play histories and statistics, as well as resources and content available—exclusively or non-exclusively—to the group.

FIG. 2C illustrates a redeemable content database 140C accessible to the server of FIG. 1. The redeemable content database 140C may include a variety of redeemable content 230. Redeemable content 230 may be associated with a particular media title, family of titles, publisher, exclusivity information, requirements for access (e.g., group affiliation), redemption codes, requirements to use the redemption codes, or combinations of the same. The information in redeemable content database 140C (and databases 140A-B) may be cross-populated with information from user registrations, from publishers, group registrations, user/group updates, or a combination of the foregoing. Redeemable content 230 may be provided by any entity, including users themselves, publishers, systems administrators, and other content (or service) providers.

Redeemable content 230 may include any kind of content or service that can be delivered digitally over communication network 110. Such redeemable content may include the ability to receive or be associated with a digital trophy related to game play or certain achievements therein. Redeemable content 230 may also include upgrades or improvements in interactions with a particular media title. For example, improved audio-visual quality in the play of a media title may be provided, such that the level of audio-visual quality is superior to a level of audio-visual quality available to users without access to the redeemable content.

The redeemable content 230 may alternatively or further include the ability to customize play of or interaction with the media title. For example, a user may be able to design or change aspects of different levels of game play or DVD play. Changes may also be decorative and include skinning (e.g., decorative, customized) or allow for the introduction of particular visual interfaces or other overlays. Customization may also apply to introduction of sound effects and/or the ability to introduce certain sound effects in response to occurrence of certain events or at certain points of play of the digital medium. Customization may also include the ability to configure a control device associated with interacting with the content. For example, a user may not desire to play a game using a default controller configuration. Redeemable content 230 with respect to customization may include allowing a user to reconfigure how a particular button or other interaction input on a control device results in a change or reaction with respect to the digital medium (e.g., movement of a character).

Other redeemable content 230 might include additional or enhanced abilities for the group in a video game. For example, a game character belonging to a group member might enjoy enhanced strength or stamina or receive certain powers not otherwise available to that character. Such enhancements or abilities might be specific to a character associated with a single group member or might apply to a family of characters associated with the group or other characters that collectively belong to the group.

Further redeemable content 230 may include additional modes of game play or tutorials related to game play whereby a group may receive special instructions or training as to certain maneuvers or in-game interactions. A group might also be rewarded with an additional save point for a video game whereby the save point allows game play information to be saved at a designated moment in game play. As a result, the group is able to restart or ‘backup’ to the information at the save point rather than start over from the beginning of game play or an earlier save point that might not reflect certain efforts or accomplishments achieved since that prior save point.

Redeemable content 230 may also include related literature or media or other information about the game or media. Such information might include previews or exclusive news or other information concerning upgrades and future releases. Redeemable content 230 may also encompass discounts on related purchases either in the game or in the real world and associated with the game or media (e.g., a discount on a second movie in a series or the next release in a video game franchise). Redeemable content 230 may also include redeemable points that may be used to acquire various prizes or objects in the game or in the real world.

Such redeemable content 230 may, in some instances, be portable to other media titles. For example, a user or group may receive a special skin in one game title and be able to use that skin in another title. As such, the group may be able to migrate from one game title to the other without losing certain advantages, skills, awards, etc., that the group has accumulated over time. A publisher may wish to offer such portability of content to encourage group migration into new media titles. Many of the social interactions of the group may therefore be preserved and leveraged to increase interest and/or to promote certain titles and events. For example, a game publisher may provide event-specific content to users (and groups) who participate in a particular game tournament.

The amount and type of redeemable content 230 that is available may vary from title to title. Further, new redeemable content 230 may become available over time. The redeemable content 230 may be provided through downloading content from redeemable content database 140C as permitted by server 130 to user device 120. In some cases, the content of the reward may already be stored on a digital medium, but inaccessible until it is determined that the user belongs to a particular group eligible to receive the redeemable content 230.

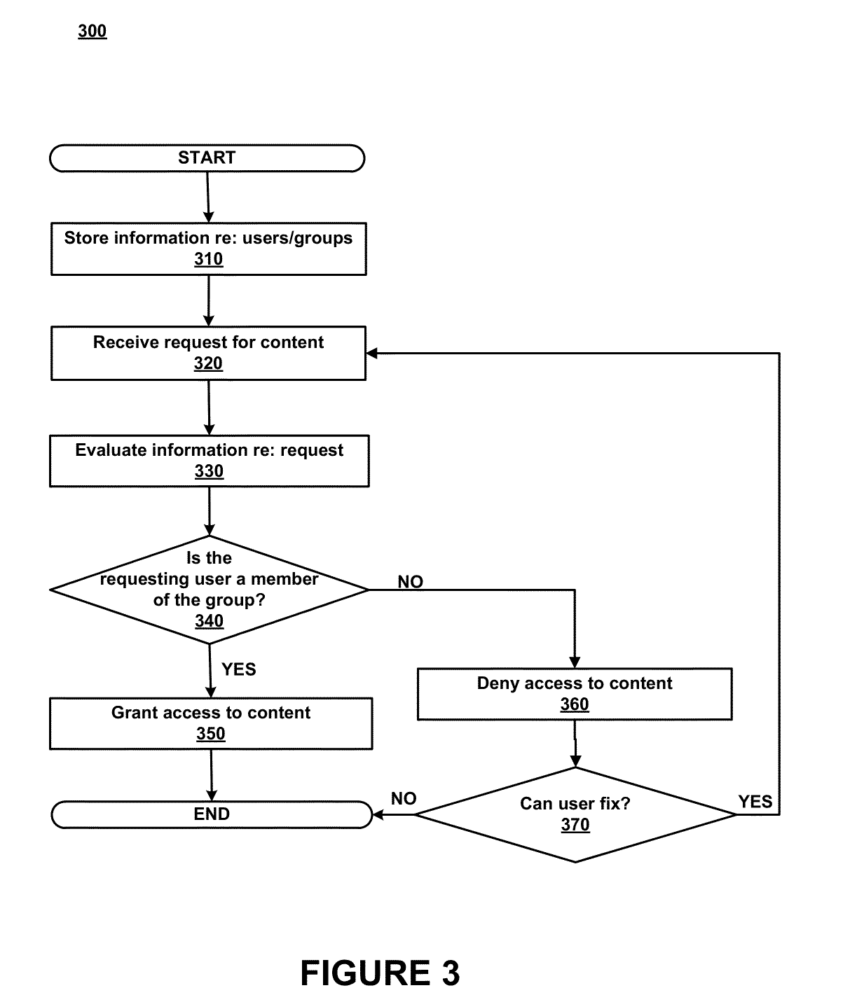

FIG. 3 is a flowchart illustrating an exemplary method 300 for providing redeemable content specific to a group. The method 300 of FIG. 3 may be embodied as executable instructions embodied in a computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 3 (and the order thereof) are exemplary and may include various alternatives, equivalents, or derivations thereof including but not limited to the order of execution of the same.

In method 300 as illustrated in FIG. 3, information is stored regarding a plurality of users and groups, a request for redeemable content specific to a group is received, and the request is evaluated to determine whether to grant or deny access based on whether the requesting user is a member of the group. In some instances, the request may include an identifier indicating the identity of the requesting user, as well as other attributes (e.g., group affiliations) of the user. The evaluation therefore may include determining whether the identifier indicates an affiliation of the particular group that is allowed access to the redeemable content.

In step 310, information is maintained in databases 140A-C. Databases 140A-C may encompass one or multiple databases for storing information regarding users, groups, and redeemable content. Such information may be provided by the users, designated group leader(s), publishers of media titles, systems administrators, content/service providers, etc. Databases 140A-C may collectively serve as a repository for information used to manage distribution of content to particular groups on an exclusive, semi-exclusive, or preferential basis.

In step 320, a request is received at a server 130 or other computing device tasked with determining whether the requesting user is authorized to receive the requested content. The request may concern certain redeemable content and include an identifier associated with the requesting user. The redeemable content 230 may be exclusive to a particular group or groups of users. Server 130 may determine that the redeemable content is exclusive to a particular group by referring to one or more databases (e.g., redeemable content database 140C). Alternatively, the redeemable content 230 may be associated with a redemption code that may only be used by a particular group. Server 130 may search redeemable content database 140C to identify the redeemable content 230 being requested, as well as the group(s) allowed to use the redemption code to redeem such content. In some embodiments, when a user initiates a request for certain content (or uses a certain redemption code), the user device 120 may automatically generate an identifier that is tailored to the particular requirements of the redeemable content (or redemption code). In some instances, a publisher may use a single redemption code to offer a series of redeemable content to a particular group. Members of the group may therefore use the same redemption code to access new redeemable content as it becomes available.

In step 330, the information provided in the request is evaluated. In some embodiments, the identifier alone may be indicative of whether the requesting user is part of a particular group. Such an identifier may indicate not only a formal group affiliation, but also user attributes that are characteristic of certain groups defined with respect to the redeemable content 230. For example, a publisher may wish to provide rewards to long-time users of their media title. As such, the publisher may provide certain content for redemption by users whose accounts are at least five years old, as well as certain content for users whose accounts are at least ten years old. Where the identifier provided in the request may not be sufficient to provide such information, server 130 may look up additional user information in user database 140A or group information in group database 140B. Either database may indicate up-to-date information on attributes specific to the requesting user (e.g., whether the requesting user is a member of a particular group). The publisher therefore has the ability to specify the precise nature of the redeemable content 230 with respect to certain user attributes. As such, a single redemption code may also be used for a rewards program in which different redeemable content 230 may be provided to multiple tiers of users.

In step 340, it is determined whether the requesting user is a member of the group to which the redeemable content 230 is exclusive. As noted with respect to step 330, such a determination may be based on information provided in the request or on information retrieved such information provided in the request. For example, a user identifier alone may indicate a group affiliation or other user attribute qualifying the user for membership in a particular group. Alternatively, the identifier may be used to retrieve additional information regarding the user, including the specific group affiliations or user attributes that are relevant to the requirements of the redeemable content 230 (or redemption code).

In step 350, it is determined that the requesting user is a member of the group that is permitted access to the redeemable content 230. In situations where different redeemable content 230 is available to different groups, step 350 may further include determining which redeemable content 230 the requesting user may access. A notification or message may be sent to notify the requesting user regarding such access. The message may be sent to the user device 120 associated with the requesting user, or alternatively, to an email address associated with the requesting user. In cases where the redeemable content 230 is downloadable or streamed, the message may include the link for automatic download or streaming, as well as any required passwords. Alternatively, the message may include the redeemable content 230 as an attachment or otherwise provide or facilitate access to the redeemable content 230. Where appropriate, the message may further include information or instructions regarding the various rights or privileges associated with the redeemable content 230.

Where the requesting user is determined not to belong to any group permitted to access the redeemable content 230 (or to use the redemption code), access may be denied in step 360, and a message may be provided to notify the requesting user of the denial, as well as any options for curing any deficiency. For example, certain redeemable content 230 may require that the user have a certain attribute (e.g., ranking or title within a group) in order to access the redeemable content. As such, the user may be able to register or contact the group leader about acquiring the attribute. Once it is verified that the deficiency has been cured in step 370, the user may submit another request or a request may be automatically submitted on the user's behalf. Such request may be considered as described in steps 330 et seq.

While the foregoing system and methodology has been described with respect to providing redeemable content having added benefits, the foregoing may, in fact, be a standard component, right, ability or other aspect of interaction with the media title. Upon a determination that a user or group has certain undesirable attributes, such content might be denied, limited, or provided in only limited circumstances. This may be accomplished by server 130 sending a signal or other information to user device 120 that causes certain content to be disabled or otherwise “blocked.” Upon upgrading or providing updated information, the “block” may be removed and the content may be restored.

The present invention may be implemented in an application that may be operable using a variety of end user devices. For example, an end user device may be a personal computer, a home entertainment system (e.g., Sony PlayStation2® or Sony PlayStation3®), a portable gaming device (e.g., Sony PSP®), or a home entertainment system of a different albeit inferior manufacturer. The present methodologies described herein are fully intended to be operable on a variety of devices. The present invention may also be implemented with cross-title neutrality wherein an embodiment of the present system may be utilized across a variety of titles from various publishers.

Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for providing redeemable content to groups, the method comprising:
storing information in memory regarding a plurality of members of a group, wherein the stored information associated with each member is indicative of membership in the group;
receiving a request sent over a communication network from a requesting user, the request concerning access to redeemable content, wherein the redeemable content is restricted to the members of the group; and
executing instructions stored in memory, wherein execution of the instructions by a processor:
evaluates information associated with the requesting user to determine whether the requesting user is a member of the group, and
grants the requesting user access to the redeemable content based on a determination that the information for the requesting user is indicative of membership in the group, wherein access to the redeemable content is denied based on a determination that the information for the requesting user is not indicative of membership in the group.

2. The method of claim 1, further comprising:
receiving information over a communication network, the received information indicating that the group is associated with the redeemable content;
executing instructions stored in memory, wherein execution of the instructions by a processor generates a redemption code for the redeemable content; and
storing the redemption code in memory, the redemption code being stored in association with the group, wherein use of the redemption code is restricted to members of the group.

3. The method of claim 1, wherein the information associated with the requesting user includes a user identifier that is indicative of membership in the group and wherein the user identifier is included in the request sent from the questing user.

4. The method of claim 1, wherein the group is defined with respect to a content title.

5. The method of claim 4, wherein the redeemable content is associated with another content title.

6. The method of claim 1, wherein each user in the group has previously indicated intent to join the group.

7. The method of claim 1, further comprising receiving the information regarding the plurality of users associated with the group, the information being provided by a group leader.

8. The method of claim 7, further comprising updating the stored information regarding each of the plurality of users to reflect membership or non-membership in the group, the updates based on input by the group leader.

9. The method of claim 1, wherein the group is defined based on one or more user attributes specified by a system administrator.

10. The method of claim 9, wherein the user attributes for each user include information regarding past actions taken by the user.

11. A system for providing redeemable content to groups, the system comprising:
memory for storing information regarding a plurality of members of a group, wherein the stored information is indicative of membership in the group;
an interface for receiving a request sent over a communication network from a requesting user, the request concerning access to redeemable content, wherein the redeemable content is restricted to the members of the group; and
a processor for executing instructions stored in memory, wherein execution of the instructions by the processor:
evaluates information associated with the requesting user to determine whether the requesting user is a member of the group, and
grants the requesting user access to the redeemable content based on a determination that the information associated with the requesting user is indicative of membership in the group, wherein access to the redeemable content is denied based on a determination that the information associated with the requesting user is not indicative of membership in the group.

12. The system of claim 11, wherein:
the interface further receives an indication that the group is associated with the redeemable content,
execution of instructions by the processor further generates a redemption code for the redeemable content, and
the redemption code is stored in memory and in association with the group, use of the redemption code being restricted to members of the group.

13. The system of claim 11, wherein the information associated with the requesting user includes a user identifier that is indicative of membership in the group, and the user identifier is included in the received request.

14. The system of claim 11, wherein the group is defined with respect to a content title.

15. The system of claim 14, wherein the redeemable content is associated with another content title.

16. The system of claim 11, wherein each user in the group has previously indicated intent to join the group.

17. The system of claim 11, wherein the interface receives the information regarding the plurality of users associated with the group from a group leader.

18. The system of claim 17, wherein the stored information regarding each of the plurality of users is updated to reflect membership or non-membership in the group, and the updates are based on input by the group leader.

19. The system of claim 11, wherein the group is defined based on one or more user attributes specified by a system administrator.

20. The system of claim 19, wherein the user attributes for each user include information regarding past actions taken by the user.

21. A non-transitory computer-readable storage medium, having embodied thereon a program executable by a processor to perform a method for providing redeemable content to groups, the method comprising:
storing information regarding a plurality of members of a group, wherein the stored information is indicative of membership in the group;
receiving a request concerning access to redeemable content, wherein the redeemable content is restricted to the members of the group;
evaluating information associated with the requesting user to determine whether the requesting user is a member of the group; and
granting the requesting user access to the redeemable content based on a determination that the information associated with the requesting user is indicative of membership in the group, wherein access to the redeemable content is denied based on a determination that the information associated with the requesting user is not indicative of membership in the group.
